(19) United States
(12) Patent Application Publication
(10) Pub. No.: US 2006/0249718 A1
(43) Pub. Date: Nov. 9, 2006

(54) Moving system for a cableway plant comprising two hauling cables

(75) Inventor: Ferruccio Levi, Milan (IT)

Correspondence Address: HEDMAN & COSTIGAN P.C., 1185 AVENUE OF THE AMERICAS, NEW YORK, NY, 10036, US

(73) Assignee: HIGH TECHNOLOGY INVESTMENTS B.V.

(21) Appl. No.: 11/406,608

(22) Filed: Apr. 19, 2006

(30) Foreign Application Priority Data
May 3, 2005 (IT) MI2005A 000800

(51) Int. Cl. B66D 1/26

(52) U.S. Cl. 254/290

(57) ABSTRACT

Simplified regulation and balancing system applicable to cableway plants, of the continuous or to-and-fro type, equipped with two hauling cables functioning in parallel. In a system according to the invention, the two cables are moved by distinct pulleys with separate winches; the kinematic chains of the two winches however are connected to each other by a device which is structurally similar to a car differential, whose outer box is kept blocked during normal functioning. In this way, the two winches are mechanically constrained and can rotate only at the same speed. By rotating the differential box with an external system, a corresponding difference in the rotation rate is actuated between the two motor shafts; the rotation can take place, for example, with a small balancing motor-reducer which activates a toothed crown integral with the box.

The present invention relates to a simplified regulation and balancing system which can be applied to cableway plants, of the continuous or to-and-fro type, equipped with two hauling cables functioning in parallel.

Known plants of this type are, for example, systems currently called DMC and FUNITEL, corresponding to EP0093680, both of the continuous type; normal to-and-fro cableways can also be equipped with two hauling cables, as also other future types of plants.

In the presence of two hauling cables, in particular in aerial plants, the problem arises of the speed synchronization and the torque distribution between the two cables; a difference in speed, in fact, even if extremely small, when prolonged with time, would sooner or later cause an irregular and unacceptable asset of the vehicle.

Two systems are currently used for overcoming this problem.

According to the first system, the two hauling cables (which can also be only one cable ring which effects two turns) are moved by a single winch equipped with two driving pulleys integral with each other, or by a single driving pulley with two races; this system guarantees simply synchronization, provided that the two integral races always have exactly the same diameter; the system therefore requires control of the diameter parity and the possibility of rapidly intervening (for example by the turning of the race) in the case of even a small variation due, for example, to different wear of the washer.

This system also has the defect that, if there were an accidental slippage of one of the two cables with respect to the other, particular equipment is necessary for reinstating the normal functioning, and this reinstatement requires time during which the passengers are compelled to remain immobile on the line.

The second system comprises two completely separate winches, and complex electronic equipment for ensuring the regular running, with synchronization of the speed and torque distribution; to ensure synchronization also during the mechanical braking phases (with electronic equipment which is not always functioning) in this phase the two driving pulleys are normally made mechanically integral with suitable devices.

The electronic control equipment has currently reached a high degree of functionality and reliability, but this type of equipment is still complex and costly and can cause breakdowns with consequent sudden stoppages of the plant.

Furthermore, in spite of the reliability reached, there is always the possibility of a sudden malfunctioning and the plant must be dimensioned and, in particular, the vehicles and line structures to deal with all types of malfunctioning without danger for the passengers.

An objective of the present invention is to obtain a simple and reliable regulation system for plants of this type, which allows economical synchronized functioning without creating further potential breakdowns; the system also allows a simple and rapid reinstatement of the correct configuration in the case, for example, of slippage of the cables on one of the races.

In a system according to the invention, the two cables are moved by distinct pulleys with separate winches; the kinematic chains of the two winches, however, are advantageously connected with each other in correspondence with the rapid shafts of the reducers, by a device which is structurally similar to a car differential, whose external box is kept blocked during normal functioning. At this moment the two winches are mechanically constrained and can only rotate at the same rate.

By rotating the differential box with an external system, a corresponding difference in the rotation rate is actuated between the two motor shafts; the rotation can take place, for example, with a small balancing motor-reducer which activates a toothed crown integral with the box.

The final objective of the regulation system is to ensure the running of the vehicles in normal asset, i.e. without torsional or vertical veering due to the surpassing of one cable with respect to the other; in the system according to the invention the activation of the balancing motor-reducer can be effected on the basis of a feedback signal connected to the asset of the vehicles; in particular:

in a system of the continuous type, such as DMC and FUNITEL, a variation in the speed between the two hauling pulleys (continuous or sudden) causes the vehicles to arrive at the station with a progressively increasing torsional inclination; this torsional inclination can be easily measured by the station equipment, and the relative signal is used to activate the balancing motor-reducer which reinstates the correct asset

in an intermittent system, or in any case equipped with a limited number of large-dimensional vehicles (normally 2), it is possible to verify the correct asset of the vehicle with equipment on board the vehicle itself, which sends the signal to the balancing motor-reducer.

The motor-reducer which moves the differential box is advantageously of the irreversible type (for example with a worm screw reducer) so that it also acts as a rigid mechanical connecting system between the two winches when velocity parity is guaranteed (for example during the braking phases).

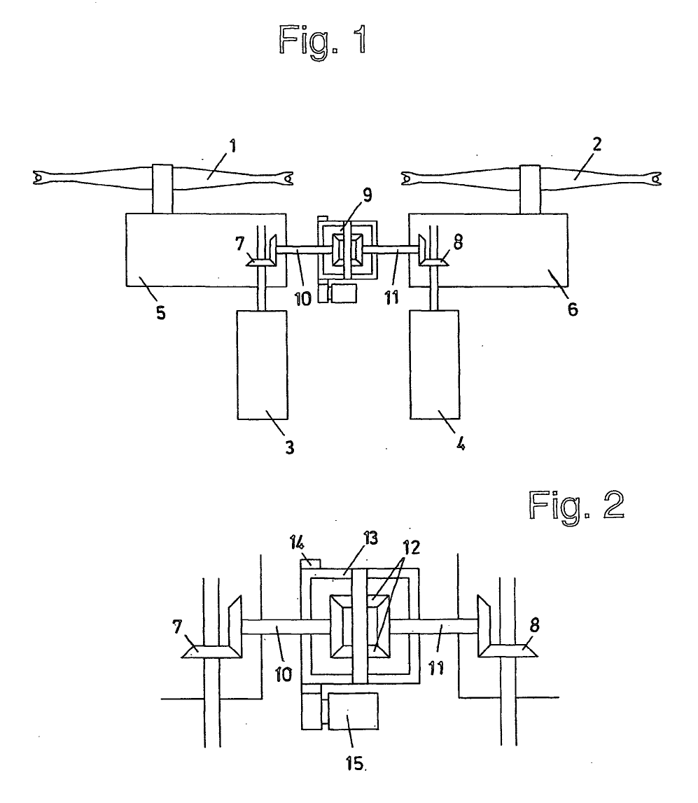

FIG. 1 shows one of the possible lay-outs of a movement system according to the invention.

The two driving pulleys 1 and 2 are moved by electric motors 3 and 4 with the interposition of geared reducers 5 and 6; conical torques 7 and 8 are inserted on the rapid shafts of the reducers.

A differential system 9, connected to the conical torques of the reducers through the rapid shafts 10 and 11, is situated between the two reducers; the conical torques are organized so that when the two pulleys move the plant in the same direction, the two shafts 10 and 11 rotate in the opposite direction.

FIG. 2 represents a detail of the differential system 9, illustrating the external box 13 integral with the satellite gears 12 and with the outer toothed crown 14; the box can be rotated or blocked by the irreversible motor-reducer 15 which acts on the toothed crown 14.

When the rotation of the box 13 is blocked, the rapid shafts 10 and 11, made integral by the satellites 12, compel the two motors 3 and 4 and the two pulleys 1 and 2 to rotate at the same velocity; if, on the other hand, the box 13 is rotated with an angular velocity ω, the angular velocity of one of the shafts is increased by ω/2 whereas that of the other is reduced by ω/2.

During normal functioning, the satellite-holder box 13 is usually kept blocked; if the two pulleys do not have exactly the same diameter, however, the two cables will move at a different rate and this is revealed sooner or later by the control devices; these send a feedback signal to the motor-reducer 15 which causes the box 13 to rotate until the correct functioning has been reinstated.

In general, the rotation speed of the motor-reducer 15 corresponds to the difference in velocity of the two motors 3 and 4, whereas the torque transmitted corresponds to the torque difference between the same motors; consequently, with a suitable regulation of the motor-reducer 15, with respect to velocity and/or torque, it is also possible to integrate or substitute the normal regulation and balancing functions of the main motors.

1. An aerial or ground cableway plant, of the continuous, intermittent or back-and-fro type, wherein the vehicles are moved by at least two hauling pulleys which can also depend on a single cable ring, characterized in that the two hauling pulleys are moved by separate winches, but connected by a mechanical device capable of causing a small difference in velocity between the two winches, positive or negative, according to the commands of a suitable feedback signal, or preventing a difference in velocity caused by external factors.

2. The cableway plant according to claim 1, characterized in that said mechanical device consists of a system which is structurally similar to a common car differential, whose outer box can be rotated by suitable motorization, or blocked by a braking system.

3. The plant according to claim 2, characterized in that said motorization comprises at least one reducer of the irreversible type, capable of also acting as a blocking device when not fed.

4. The plant according to claim 2, characterized in that said motorization is activated on the basis of a feedback signal coming from a variation in the asset of the vehicles, measured directly on the vehicle.

5. The plant according to claim 3, characterized in that said motorization is activated on the basis of a feedback signal coming from a variation in the asset of the vehicles, measured directly on the vehicle.

6. The plant according to claim 2, characterized in that said motorization is activated on the basis of a feedback signal coming from a variation in the asset of the vehicles, measured upon arrival at the station.

7. The plant according to claim 3, characterized in that said motorization is activated on the basis of a feedback signal coming from a variation in the asset of the vehicles, measured upon arrival at the station.

8. The plant according to claim 2, characterized in that said motorization is activated on the basis of a feedback signal coming from the velocity measurement of the cables in one of the stations.

9. The plant according to claim 3, characterized in that said motorization is activated on the basis of a feedback signal coming from the velocity measurement of the cables in one of the stations.

10. The plant according to claim 2, characterized in that said motorization is activated on the basis of a combination of feedback signals coming from a variation in the asset of the vehicles, measured directly on the vehicle, coming from a variation in the asset of the vehicles, measured upon arrival at the station and coming from the velocity measurement of the cables in one of the stations.

11. The plant according to claim 3, characterized in that said motorization is activated on the basis of a combination of feedback signals coming from a variation in the asset of the vehicles, measured directly on the vehicle, coming from a variation in the asset of the vehicles, measured upon arrival at the station and coming from the velocity measurement of the cables in one of the stations.

12. The plant according to claim 1, characterized in that said mechanical device is inserted between the rapid shafts of the reducers of two winches.

13. The plant according to claim 2, characterized in that said mechanical device is inserted between the rapid shafts of the reducers of two winches.

14. The plant according to claim 1, characterized in that said mechanical device is activated by one or more variable speed electric motors, of the direct or alternate current type.

15. The plant according to claim 2, characterized in that said mechanical device is activated by one or more variable speed electric motors, of the direct or alternate current type.

16. The plant according to claim 2, characterized in that the motorization of said mechanical device is regulated with respect to the torque and/or the angular speed so as to integrate the regulation functions of the main motors.

17. The plant according to claim 3, characterized in that the motorization of said mechanical device is regulated with respect to the torque and/or the angular speed so as to integrate the regulation functions of the Main motors.
